(19) United States
(12) Patent Application Publication
(10) Pub. No.: US 2008/0189773 A1
(43) Pub. Date: Aug. 7, 2008

(54) Securing User Logins with Wv Bindings and Transports

(76) Inventors: Nick Maiorano, Montreal (CA); Sylvain Legault, Pierrefonds (CA); Patrice Hebert, Anjou (CA); Gaetan Vachon, Verdund (CA)

Correspondence Address: COATS & BENNETT/OZ, 1400 CRESCENT GREEN, SUITE 300, CARY, NC, 27518, US

(21) Appl. No.: 12/088,456

(22) PCT Filed: Sep. 29, 2006
(86) PCT No.: PCT/CA2006/001611

§ 371 Date: Mar. 31, 2008

Related U.S. Application Data
(60) Provisional application No. 60/721,963, filed on Sep. 30, 2005.

(30) Foreign Application Priority Data
Sep. 30, 2005 (CA) 2521770

(51) Int. Cl. H04L 9/32; G06F 21/00

(52) U.S. Cl. 726/5; 726/12

(57) ABSTRACT

There is disclosed a method and system for communicating a secure login request between a mobile client and a destination server providing access to a service, the method to be implemented by a disclosed gateway adapted to communicate with both the mobile client and the destination server. The gateway may also implement appropriate protocol conversions between otherwise incompatible client and server pairs. Wireless instant messaging, email and other such services are considered as exemplary services for the disclosed method, system and gateway.

### FIELD OF THE INVENTION

The present invention relates to a method and system for securing user logins with WV bindings and transports. In particular, the present invention relates to a method and system for communicating information between a mobile device and a destination server and, more particularly, to a system and method for securely communicating user information between the mobile device and the destination server.

### BACKGROUND OF THE INVENTION

A number of mobile carriers offer to their end-users access from their mobile device to the instant messaging (IM) services of the leading Internet portals. In this mobile access service, end-users can login to their IM service, and use it on their mobile device such as for seeing the presence of their contacts and engaging in chats with them. This mobile access to IM services is offered by mobile carriers to access, for instance, the IM services of MSN, AOL and Yahoo.

The Client to Server Protocol (CSP) defined by the Open Mobile Alliance (OMA) in its Wireless Village (WV) Mobile Instant Messaging and Presence Services (IMPS) standard clearly defines transports and bindings that can be used by mobile clients to access IM services. As transport methods, that is the underlying protocol used to transmit data over the wire, the CSP recognizes SMPP, WTP and HTTP. As transport bindings, that is the encoding of the data when transmitted over the transport, the CSP recognizes SMS, XML and binary XML (BXML). Many combinations of bindings and transports are permissible in the CSP. A mobile client 14 is free to choose the binding and transport combination that best meets its needs to form the basis of communication with a CSP compliant server, provided that the server supports the combination.

In many instances, protocols implemented in the mobile devices for accessing the IM services do not correspond to the protocols supported by the providers of the IM services. This may arise for several reasons, such as when the mobile devices do not support the base Internet IP protocols used by the IM services, or when the binding of the protocol messages is in a different format than that supported by the IM services. To overcome this problem, mobile operators may deploy an IM gateway for performing conversion of the protocol used by the mobile device into the protocol used by the IM services that the mobile device wishes to access.

Mobile operators and IM service providers however, generally have corporate policies that mandate that user passwords be encrypted when flowing through the chain of network elements during user login procedures. For accessing a particular IM service, login requests from mobile devices typically flow across at least three sites, namely the mobile network operator, the site of the IM gateway performing the protocol conversion and the site of the IM service provider. Connections between these sites may or may not be over the public Internet.

In this context, very few solutions exist in the prior art to provide secure communication of passwords between the above network elements, generally leading to a number of client and service provider incompatibilities greatly reducing mobile client access to IM services.

The CSP defines 2 login methods. A 2-way login and a secure 4-way login. The 2-way login is the classic method of login that involves a client submitting a user name and password and receiving a status response. The status response is generally either login successful or login failed in the event the user name and/or password is invalid. The name 2-way login is derived from the fact that there are only 2 messages (one request and one response) involved in the login. One key property of this type of login is the fact that the password is submitted in clear text. When the transport is non-encrypted, there is a definite security risk in the form of traffic interception by an unauthorized third party.

To implement a secure 2-way login procedure, a virtual private network (VPN) or the like may be established between each network element. That is, a first VPN may be deployed between the mobile network site and the IM gateway site and a second VPN may be deployed between the IM gateway site and the IM Service Provider site. This solution is however only applicable when the IM Service Provider supports the same protocol transports and bindings as used by the mobile client and the IM gateway. Also, mobile operators generally prefer to avoid this solution as costs associated therewith for the deployment of VPNs (or leased lines) are generally high.

As such, a second solution involves the use of a secure 4-way login method that reduces the need for VPNs. This form of login ensures that the password is never sent over the network in clear text, allowing the password to be sent securely over a public network. To achieve this, there are four steps. The first step is a negotiation of the hashing functions used to encrypt the password between a client and a server. The above CSP standardizes 4 well-known hashing functions: SHA, MD4, MD5 and MD6. The client submits the functions it supports and the server responds with the hashing function it agrees to use. This will be any function in the intersection of the supported functions between the client and the server. The secret key (used as a seed in the hashing function) is also included in the same server response.

The client then encrypts the password using the secret key and hashing function and produces a message digest. The message digest is communicated to the server. The server compares this digest with its own internal digest, obtained by re-encrypting the password (already known to the server) with the same secret key and function. As with 2-way login, the server responds with either a success or failure code. These hashing functions are generally known as trapdoor one-way functions. That is, it is generally mathematically intractable to deduce the original clear-text password even if the secret key and message digest are known. This achieves the goal of rendering the password completely secure.

However, this solution requires that both the mobile client and the IM Service Provider support a secure 4-way login method and support the same protocol transports and bindings. Furthermore, a 4-way login method is generally only available if XML or BXML bindings are supported by the mobile client and IM service provider (OMA IMPS 1.1). Finally, mobile clients generally operate from limited resources and may not be capable of password encryption.

### SUMMARY OF THE INVENTION

In order to address the above and other drawbacks, there is provided a method and gateway for communicating a secure login request between a mobile client and a destination server providing access to a service.

There is also provided a method and gateway for communicating a login request between a mobile client and a plurality of servers, each of the servers providing access to a respective service.

More specifically, in accordance with the present invention, there is provided a computer implemented method for communicating a secure login request between a mobile client and a destination server providing access to a service, the method to be implemented by a gateway adapted to communicate with both the mobile client and the destination server, the method comprising the steps of: receiving a login request from the mobile client requesting access to the service, the request comprising login information required to gain access to the service; extracting the login information from the login request; determining a secure login procedure supported by the destination server; and communicating the login information to the destination server in accordance with the secure login procedure.

Also in accordance with the present invention, there is provided a computer implemented method for communicating a login request between a mobile client and a plurality of servers, each of the servers providing access to at least one of a plurality of services, the method to be implemented by a gateway adapted to communicate with both the mobile client and the servers, the method comprising the steps of: receiving a login request from the mobile client requesting access to a service; determining based on the request a destination server selected from the servers providing access to the service; determining a secure login procedure supported by the destination server; and communicating the login request to the destination server in accordance with the secure login procedure.

Still in accordance with the present invention, there is provided a gateway for communicating a login request between a mobile client and a plurality of servers, each of the servers providing access to a respective service, the gateway comprising a first interface for communicating with the mobile client and adapted to receive a login request therefrom for access to one of the services, a processor in operative communication with the first interface, the processor interpreting the login request to determine a destination server providing access to the given service and to establish a secure login procedure supported by the destination server and a second interface for communicating the login request to the destination server in accordance with the secure login procedure.

Still further in accordance with the present invention, there is provided a secure login system for providing access to at least one of a plurality of services, the system comprising a plurality of ground end systems each comprising at least one server for providing access to at least one of a plurality of services; a mobile device comprising at least one mobile client for requesting access to at least one of said services; and a gateway. The gateway comprises a first interface for communicating with said mobile client and adapted to receive a login request therefrom for access to one of the services; a gateway module in operative communication with said first interface, said module interpreting said login request to determine a destination server selected from said servers providing access to said one of the services and to establish a secure login procedure supported by said destination server; and a second interface for communicating said login request to said destination server in accordance with said secure login procedure.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic diagram of a mobile communication system in accordance with an illustrative embodiment of the present invention;

FIG. 2 is a conceptual model of client-server communications in accordance with the illustrative embodiment of FIG. 1;

FIG. 3 is a flow-chart of a method for selecting a transport, binding and login method to be implemented between a gateway and a server in the mobile communication system of FIG. 1; and

FIGS. 4 to 9 are schematic diagrams illustrating various examples of transport, binding and login methods used in the communication system of FIG. 1 and conversions thereof implemented by a gateway between a client and a server of the system.

### DESCRIPTION OF ILLUSTRATIVE EMBODIMENTS

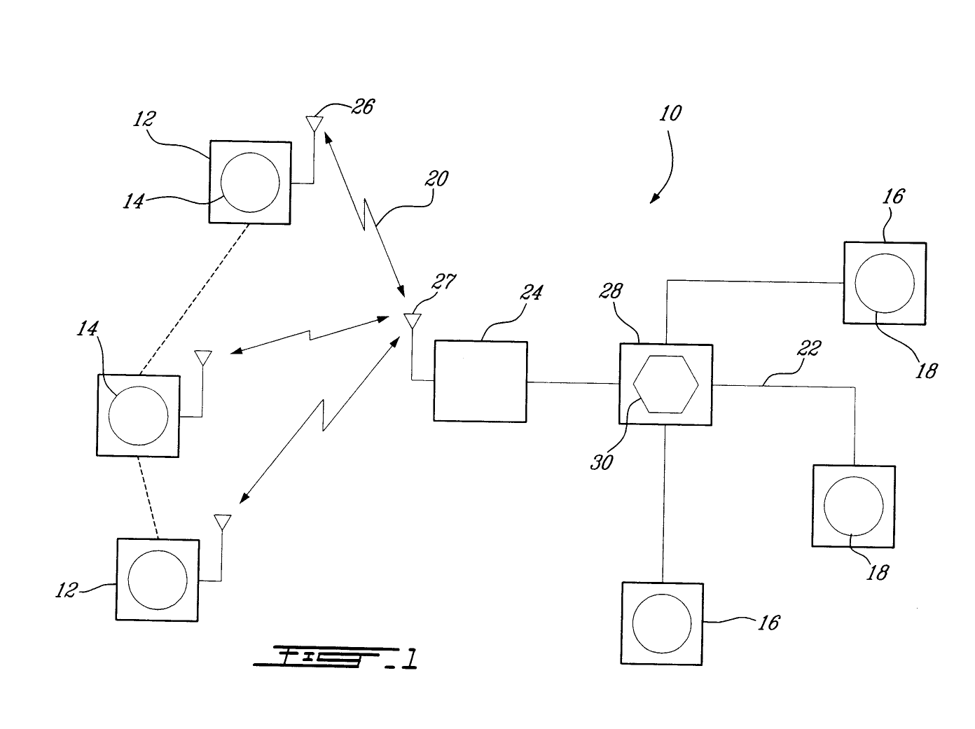

Referring to FIG. 1, and in accordance with an illustrative embodiment of the present invention, a wireless communication system, generally referred to using the numeral 10, will now be described. The system 10 is generally comprised of a plurality of mobile devices 12 each comprising at least one client 14 and a plurality of ground end systems 16 each comprising at least one server 18. The mobile devices 12 and the ground end systems 16 are interconnected by at least one wireless RF network 20 and typically a plurality of interconnected ground networks as in 22. A mobile network operator 24 provides an interface between the wireless RF network and the ground networks 22, providing the mobile devices access to the ground networks 22. In particular, each mobile device 12 is equipped with an antenna 26 through which wireless communications may be established with a corresponding antenna 27 operatively linked to the mobile operator 24.

Still referring to FIG. 1, the clients 14 and servers 18 are typically software applications running on the mobile devices 12 and ground end systems 16 respectively which take advantage of the wireless RF network 20 and interconnected ground networks as in 22 to communicate with one another. In the present example, the clients 14 are illustratively comprised of IM clients 14 for accessing selected IM services provided by the servers 18, illustratively comprised of IM servers. As will be discussed further hereinbelow, substitution of IM clients 14 and IM servers 18 for email clients and servers in the context of wireless email access may also be considered without altering the scope and general nature of the present disclosure. Other such systems involving wireless access to remote services should be apparent to a person of skill in the art.

To address potential protocol incompatibilities between the various IM clients 14 and IM servers 18, the system 10 is also comprised of an IM gateway 28 adapted to implement, when needed, various protocol conversions. These conversion mechanisms may be implemented by a gateway module 30 comprised of various conversion algorithms/software stored on memory at the gateway 28 and implemented by a gateway processor or the like. In particular, as will be discussed in greater detail hereinbelow, the IM gateway 28 is configured to optimize user accessibility to a plurality of IM services via a number of conversion algorithms/software comprised in the gateway module 30 and dedicated not only to converting communications between given client and server-supported protocols and bindings, but also to ensuring the implementation of a secure login procedure between the IM client 14 and IM server 18.

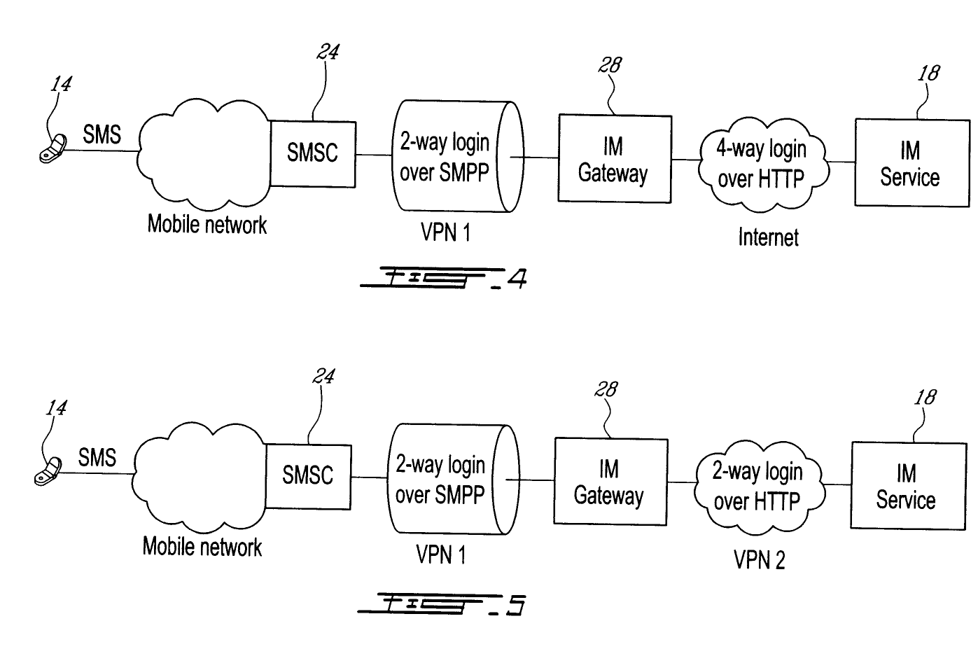

For example, the IM gateway 28, illustratively distinct in FIG. 1 from the mobile operator 24, allows IM clients 14 supporting a first set of communication protocols to interact with a selected IM server 18 supporting a second set of communication protocols incompatible with the first set by implementing, when needed, various protocol conversion mechanisms. As discussed above, these conversion mechanisms, bridging communications between incompatible peers, may be implemented by the dedicated conversion algorithms/software comprised in gateway module 30 and stored at the gateway 28. Also, the gateway 28 may be configured to provide mobile IM clients 14 communicating therewith secure login access to a number of supported IM servers 18 via the gateway module 30 by converting, for example, a secure 2-way login implemented over a VPN between the mobile operator 24 and the IM gateway 28, to a secure 4-way login method to be implemented between the IM gateway 28 and the selected IM server 18 over a public network. Further exemplary protocol and login conversions will be presented hereinbelow with reference to FIGS. 4 to 9.

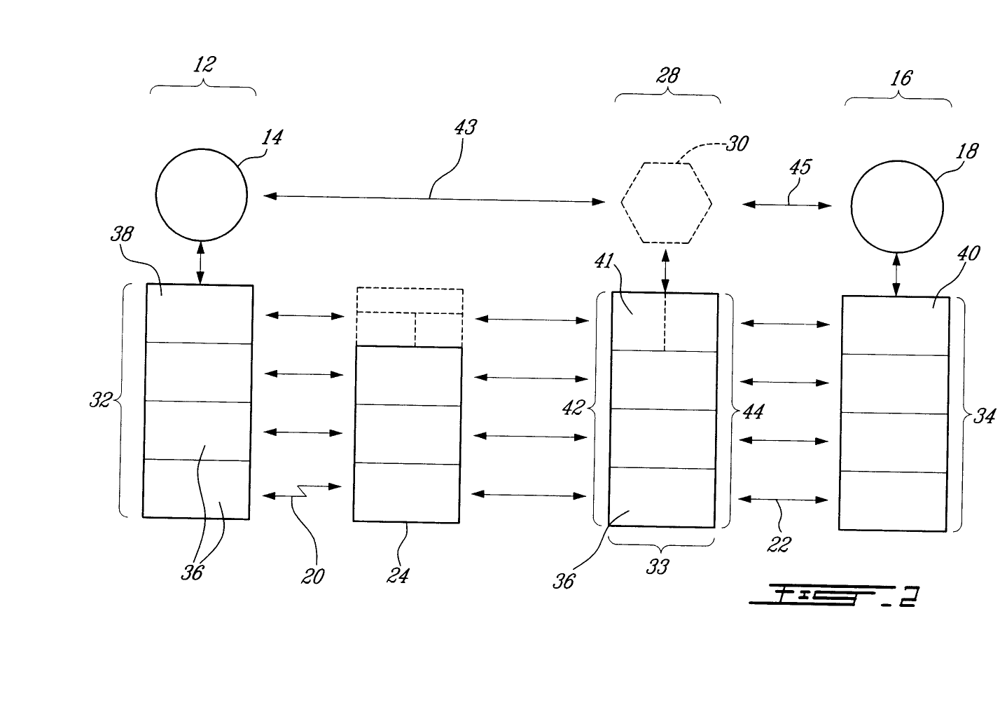

Referring now to FIGS. 1 and 2, each client as in 14 or server as in 18 typically has access to the underlying communications networks 20, 22 via protocol stacks as in 32, 34. As known in the art, use of such protocol stacks as in 32, 34 (also known as a layered architecture) provide distinct advantages in terms of transparency, interoperability and expandability. Each of the protocol stacks as in 32, 34 are divided into a plurality of layers as in 36. Although a protocol stack can have many layers, in order to provide “end to end” communications, such as those provided by the TCP/IP model, four layers are used with the upper most, or transport layer as in 38, 40 being the only layer typically accessible by either the IM client 14 or IM server 18.

In the present embodiment, the gateway module 30 of IM gateway 28 also has access to the underlying networks 20, 22 via a protocol stack 33 comprised of a plurality of corresponding layers as in 36. The gateway module 30 is generally configured to access a transport layer 41 of the gateway 28 to establish and maintain “end to end” communications with both the IM clients 14 and with the IM servers 18.

Typically, as will be described further hereinbelow, an IM client 14 wishing to access a particular IM service provided by a an IM server 18 may first establish a connection with the gateway module 30 of IM gateway 28 by requesting this establishment from its respective transport layer 38 using one or more predefined commands typically referred to as primitives. Based on the information provided in the primitives, the transport layer 38 seeks to communicate with its peer transport layer 41 and establish a logical path 43 through which data can flow, thereby allowing the IM client 14 to communicate with the gateway module 30 and vice versa.

Concurrently, the gateway module 30 may establish a connection with an IM server 18, providing access to the particular IM service requested by the IM client 14, by requesting this establishment from its transport layer 41. As such, a second logical path 45 is established through which data can flow, thereby allowing the gateway module 30 to communicate with the IM server 18. As such, gateway module 30 provides a logical bridge between the IM client 14 and the IM server 18 to implement any protocol and/or login method conversions required to provide the mobile client 14 access to a particular IM service.

Still referring to FIGS. 1 and 2, in system 10, communications between a given IM client 14 and IM server 18 are illustratively channeled through the site of the mobile operator 24 and the IM gateway 28. As presented hereinabove, the mobile operator 24 provides a communication interface between the wireless and ground networks 20, 22. This interface may or may not be used to convert communications between underlying wireless and landline protocols, depending on the nature of the communications and the type of mobile devices 12 and clients 14 considered.

The IM gateway 28 comprises a first interface 42 for communicating with the mobile client 14 and is adapted to receive a login request therefrom. Namely, communications forwarded by the mobile operator 24 are received at this first interface 42 through, for instance, a dedicated VPN or leased line established with the mobile operator 24, a public network such as the Internet, or the like. The IM gateway further comprises a second interface 44 for communicating with supported IM servers 18, again through a dedicated VPN or leased line established therewith, a public network such as the Internet, or the like.

In addition, the gateway module 30 of gateway 28 maintains dedicated conversion algorithms/software such that it may implement, between the gateway's first and second interfaces 42, 44 various protocol conversions when needed to bridge communications between an IM client 14 and IM server 18 supporting different protocols. These algorithms/software may be stored in a memory or the like and implemented by a processor or the like provided at the gateway 28. Additional hardware and/or software components of the IM gateway 28 such as RAM, ROM, information databases, look-up tables and the like should be apparent to a person of skill in the art. In general, the IM gateway 28 allows otherwise incompatible peers to communicate and, in the context of IM login procedures, in accordance with prescribed security requirements.

Note that additional network devices, such as routers or the like, may be necessary to support communications between a particular pair of peer transports layers as in 38, 40 and 41.

Still referring to FIGS. 1 and 2, the system 10 may be used to provide wireless IM clients, as in 14, secure login access to wireless Instant Messaging (IM) services. In particular, the system 10, and particularly IM gateway 28, may be configured to provide IM clients 14 access to different IM services provided by independent IM service providers, each illustratively operating a given IM server 18, even when transport, binding and/or login methods supported by each of the IM client 14 and the selected IM server 18 are generally incompatible.

As presented above, the CSP defined in the OMA WV IMPS standard presents a list of transports, namely SMPP, WTP and HTTP, and bindings, namely SMS, XML and BXML, used by mobile IM clients 14 to access IM services. Most binding and transport combinations are accepted in the CSP.

The CSP also defines 2 login methods, namely the 2-way login and the secure 4-way login. The 2-way login is the classic method of login that involves an IM client 14 submitting a user name and password in clear text to an IM server 18 and receiving a login response therefrom. As discussed above, when the transport is non-encrypted, there is a definite security risk in the form of traffic interception by an unauthorized third party.

The 4-way login method ensures that the password is never sent over the network in clear text. As discussed above, a negotiation is initiated between the IM client 14 and the IM server 18 to determine a mathematical function (e.g. a hashing function such as SHA, MD4, MD5 and MD6) to be used to encrypt the password. A secret key, used as a seed in the selected hashing function, is provided by the IM server 18 to the IM client 14 that proceeds with the encryption of the password using the selected function and secret key. The encrypted password is then sent to the IM server 18, likely over an unprotected public network, where it is verified. A login response is then sent to the IM client 14.

In the present context of system 10, the IM gateway 28 is configured to support all of the above transports, bindings and login methods, as well as all the legal combinations of bindings, transports and login methods that can be used by the mobile clients 14 and the IM servers 18, such that an IM client 14 may access any IM server 18 irrespective of the transports, bindings and login methods supported thereby. As will be discussed further hereinbelow in the appended examples, the use of costly VPNs and leased lines to ensure secure password transmissions using 2-way logins will be reduced and compatibility between IM clients 14 and IM servers 18 will be significantly increased.

For instance, the gateway 28 and the gateway module 30 thereof may be configured to favor, when applicable, the use of transport and login mechanisms not requiring an underlying VPN. This may be achieved, for example, by implementing a 4-way login between the gateway module 30 and IM server 18 via the second interface 44 of IM gateway 28 when such a login method is supported by the IM server 18, while a 2-way login method is used between the IM client 14 and gateway module 30 via the first interface 42 of IM gateway 28 over a VPN (or leased line). In this scenario, the gateway module 30 will receive the unencrypted login request form the IM client 14, extract the user name and password therefrom, and implement a 4-way login procedure with the IM server 18. Upon receipt of the login response form the IM server 18, the gateway module 30 will transmit the response to the IM client 14 in accordance with the 2-way login initiated thereby.

In addition, when a VPN is required on both sides of the IM gateway 28, the IM gateway 28 may be configured to favor protocols with the IM server 18 that are easier to support, such as protocols not requiring the setup and ongoing maintenance of long-lived connections.

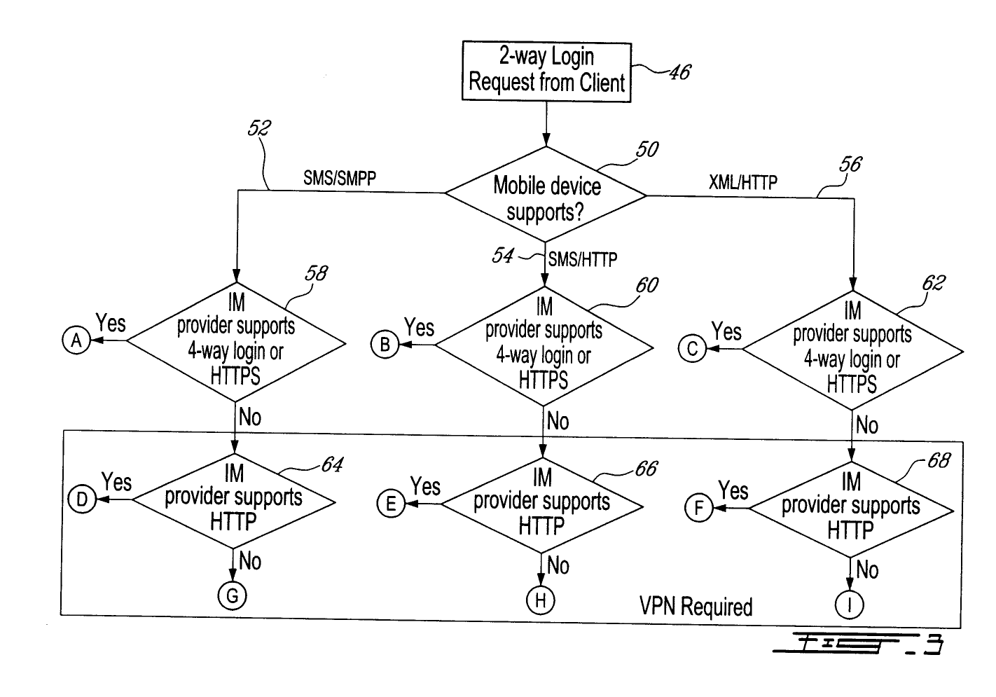

Referring now to FIG. 3, a flow-chart illustrating a protocol selection process, in accordance with the present embodiment, is presented wherein the gateway module 30 selects, based on the format and destination of a 2-way login request received from an IM client 14, a protocol and login method to be implemented between the gateway module 30 and the destination IM server 18. At step 46, a 2-way login request is received at the IM gateway 28 from an IM client 14. Specifically, the 2-way login request may be transmitted securely to the IM gateway 28 via the mobile operator 24 over a VPN or a leased line.

At step 50, the gateway module 30 evaluates the binding and transport method supported by the IM client 14/mobile operator 24, namely the binding and transport method employed by the mobile operator 24 to communicate the login request to the IM gateway 28. Using the binding and transport method provided by the OMA IMPS standard, the IM gateway 28 may be configured to accept communication of the 2-way login request over the VPN using the following binding/transport combinations: SMS/SMPP (branch 52), SMS/HTTP (branch 54), or XML/HTTP (branch 56).

At steps 58, 60 and 62, the gateway module 30 determines, based on the destination address provided within the login request and general IM service provider information stored at the IM gateway 28 associated with the destination address (e.g. server database, look-up table, etc.), whether the IM service provider from which IM services are requested (destination IM server 18) supports 4-way logins or HTTPS. If the destination IM server 18 supports 4-way logins, the IM gateway will extract the login information from the received login request and implement a 4-way login request with the destination IM server 18 over a public network such as the Internet. If the destination IM server supports HTTPS, the IM gateway will proceed with a 2-way login over HTTPS again using a public network. In either case, upon reception of a login result from the destination IM server 18, the gateway module 30 forwards the login result to the IM client 14 in accordance with the 2-way login, transport and binding methods supported by the IM client 14. These solutions are presented as solutions A, B and C in Table 1.

However, if the destination IM server 18 does not support 4-way logins or HTTPS, the login request will have to proceed over a second VPN established between the IM gateway 28 and the destination IM server 18. The gateway module 30 will nonetheless attempt to use a favourable transport and binding method to increase the efficiency of the login transaction. As such, the gateway module 30 determines at 64, 66 and 68, again based on the destination address provided within the login request and general IM service provider information stored at the IM gateway 28 associated with the destination address (e.g. server database, look-up table, etc.), whether the IM service provider from which IM services are requested supports HTTP. If so, the gateway module 30 proceeds with a 2-way login request over HTTP using the second VPN (solutions D, E and F of Table 1). Otherwise, the gateway module 30 proceeds with a 2-way login request over SMPP using the second VPN (solutions G, H and I of Table 1).

In Table 1 below, a list of conversion options that may be implemented at the IM gateway 28 are listed. In these options, a 2-way login procedure is implemented between the IM client 14 and the IM gateway 28 over a first VPN. The IM gateway 28 then proceeds in implementing a 4-way login or a 2-way login procedure with the IM server 18. Although the solutions considered at Table 1 do not provide the option of a 4-way login using an SMS binding, as defined by the OMA IMPS 1.1 standard, the IM gateway 28 may still be configured to provide such options. Namely, with the advent of the OMA IMPS 1.2 standard, 4-way logins using SMS bindings become available and are thus supported by the IM gateway 28. A person of skill in the art will understand that such options provided by the advent of the OMA IMPS 1.2 standard may be considered without departing from the general scope and nature of the present disclosure. Furthermore, the use of a compact BXML binding instead of an XML binding in the following options and examples should be apparent to the person of skill in the art.

TABLE 1
IM Gateway Conversion Options for 2-way IM Client Login Requests

| Solution | Conversion in IM Gateway |
|---|---|
| A | SMS/SMPP to 4-way login on HTTP or 2-way login on HTTPS |
| B | SMS/HTTP to 4-way login on HTTP or 2-way login on HTTPS |
| C | XML/HTTP to 4-way login on HTTP or 2-way login on HTTPS |
| D | SMS/SMPP to 2-way login on SMS/HTTP |
| E | SMS/HTTP to 2-way login on SMS/HTTP |
| F | XML/HTTP to 2-way login on XML/HTTP |
| G | SMS/SMPP to 2-way login on SMS/SMPP |
| H | SMS/HTTP to 2-way login on SMS/SMPP |
| I | XML/HTTP to 2-way login on SMS/SMPP |

Referring now to FIGS. 4 to 9, some of the above solutions are illustrated and described in greater detail. Note that the following examples show linear solutions between a given IM client 14 and a given destination IM server 18. A person of skill in the art will understand that a particular IM gateway 28 may be configured to provide any number or combination of the following and other such solutions. For instance, an IM gateway 28 operated by a given mobile operator 24 may be configured to provide conversions between protocols and login methods supported by their respective IM clients 14 and IM server 18 regularly accessed by these respective clients 14. A universal IM gateway 28 may also be considered to implement protocol and login conversions between any type of IM client 14 and IM server 18.

In FIG. 4, the mobile IM client 14 communicates a login request to a Short Message Service Center (SMSC) which forwards the request over a first VPN (VPN 1) to the IM gateway 28. In this scenario, the network link between the IM gateway 28 and the IM destination server 18 is not secured with a VPN and the HTTP protocol used between these sites in also not secure. However, the IM destination server 18 supports a 4-way login. As a result, the login may be converted into XML (or BXML) over HTTP. Furthermore, the payload of the login request will be altered and converted from a 2-way login to a 4-way login. Specifically, the gateway module 30 will receive a clear text password from the IM client 14 for which the gateway module 30 will negotiate with the IM server 18 an encryption function and secret key. The gateway module 30 will then send the password as a message digest for verification by the IM server 18. The IM server 18 will then send a login result to the gateway module 30 that will forward the result to the IM client 14 in accordance with the 2-way login method using VPN 1, an SMS binding and an SMPP transport. This scenario corresponds to solution A of Table 1.

A person of skill in the art will appreciate that the scenario presented in FIG. 4 may also be considered when the destination IM server 18 supports HTTPS. In this case, the 2-way login is maintained between the IM gateway 28 and the IM server 18 but it is still converted into XML (or BXML), this time over HTTPS.

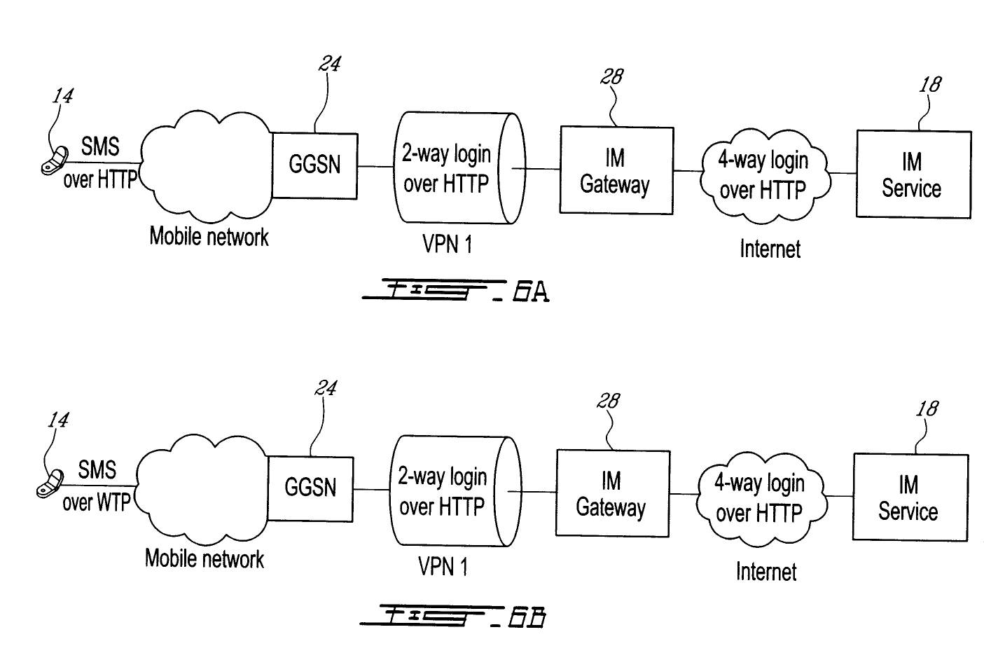

In FIG. 5, a scenario similar to that of FIG. 4 is presented, wherein the IM client 14 again communicates a 2-way login request to the IM gateway using a first VPN (VPN1) and an SMS binding over an SMPP transport. In this scenario, however, the IM destination server 18 does not support 4-way logins but still supports HTTP. As such, a 2-way login using an SMS binding and an HTTP transport is used over a second VPN (VPN 2). This scenario corresponds to solution D of Table 1.

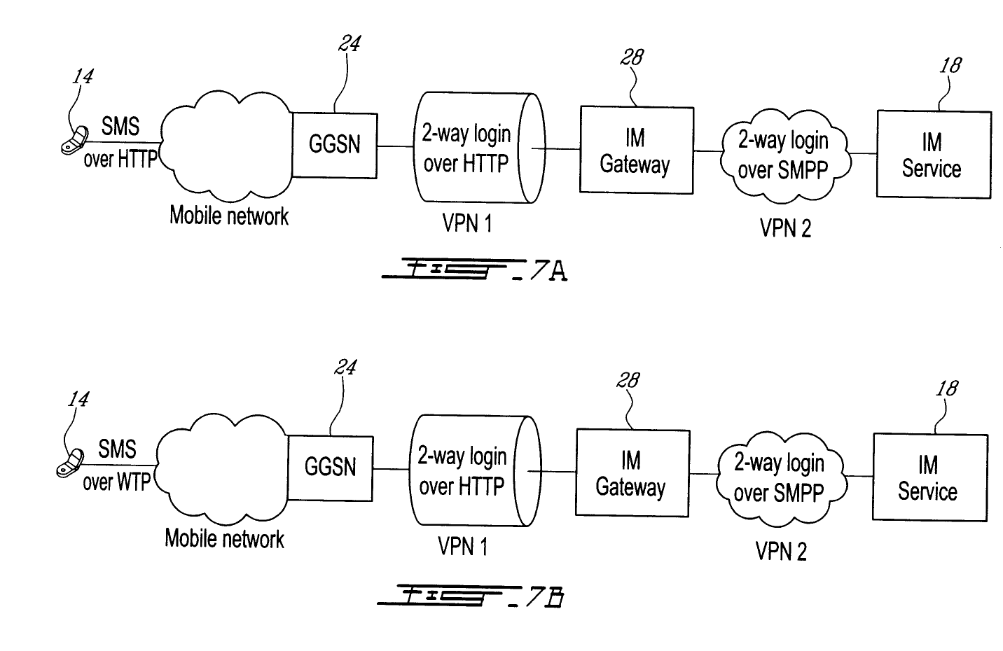

In FIGS. 6A and 6B, the mobile IM client 14 communicates a login request to a Gateway GPRS Support Node (GGSN) 24 which forwards the request over a first VPN (VPN 1) to the IM gateway 28. Whether the login is transmitted using an SMS binding over an HTTP transport or an SMS binding over a WTP transport, the GGSN forwards the request to the IM gateway 28 using an SMS binding over an HTTP transport. However, when the IM client 14 uses WTP as transport, communications between the IM client 14 and the mobile operator 24 (a GGSN in FIG. 6B) are channeled via a WAP gateway (not shown) that converts the transport from WTP to HTTP and vice-versa. As such, the GGSN need only support HTTP as transport, a transport also used to communicate with the IM gateway 28. Alternatively, a WAP gateway may be integrated within the GGSN 24 to perform the WTP-HTTP conversions.

In the above scenarios, the network link between the IM gateway 28 and the IM destination server 18 is not secured with a VPN and the HTTP protocol used between these sites in also not secure. However, the IM destination server 18 supports a 4-way login. As a result, the login may be converted into XML (or BXML) over HTTP. Furthermore, the payload of the login request will be altered and converted from a 2-way login to a 4-way login, as described above with reference to FIG. 4. Again, a 2-way login using an XML binding over an HTTPS transport may also be used if HTTPS is supported by the IM destination server 18. This scenario corresponds to solution B of Table 1.

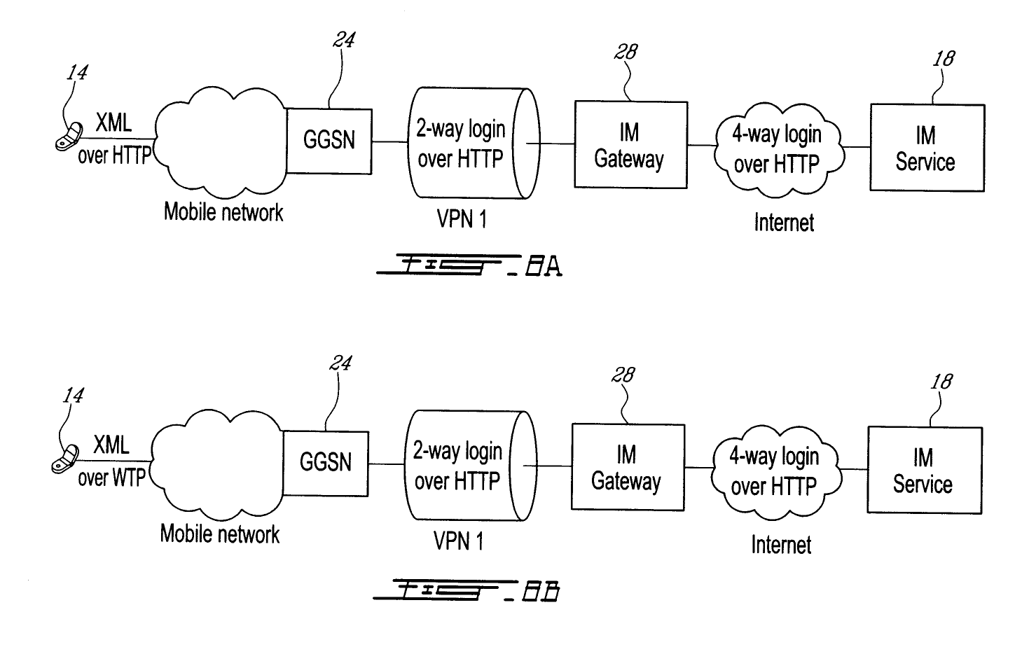

In FIGS. 7A and 7B, scenarios similar to those of FIGS. 6A and 6B are respectively presented, wherein the IM client again communicates a 2-way login request to the IM gateway using a first VPN (VPN 1) and an SMS binding over an HTTP transport (FIG. 7A) or an SMS binding over a WTP (FIG. 7B) transport. In these scenarios, however, the IM destination server 18 does not support 4-way logins nor does it support HTTP. As such, a 2-way login using an SMS binding over an SMPP transport is used over a second VPN (VPN 2). This scenario corresponds to solution H of Table 1.

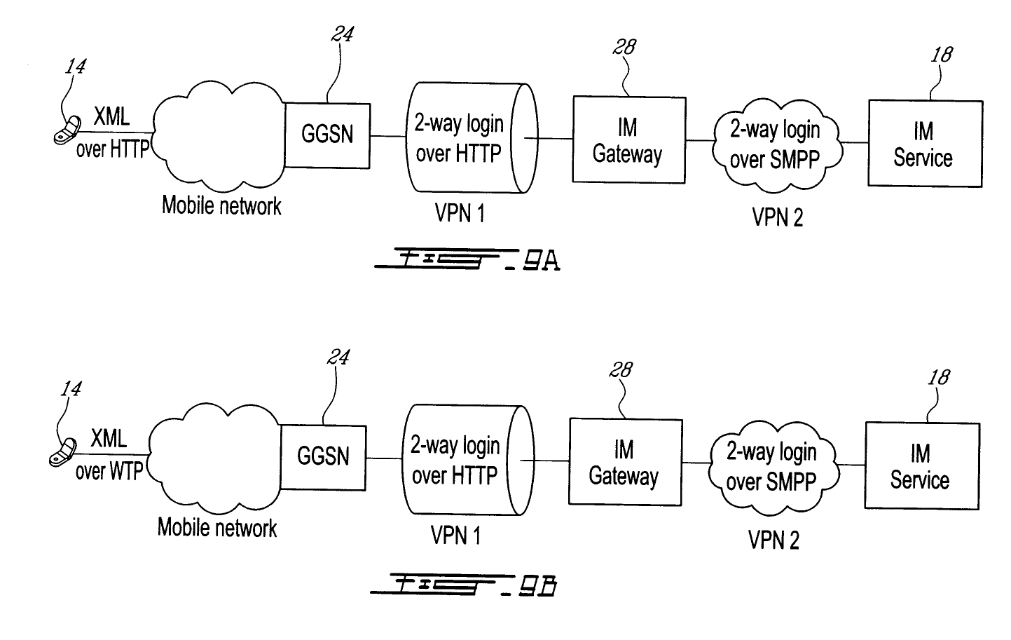

In FIGS. 8A and 8B, the mobile IM client 14 communicates a login request to a GGSN 24 which forwards the request over a first VPN (VPN 1) to the IM gateway 28. As discussed hereinabove with reference to SMS bindings in FIGS. 6A and 6B, whether the login is transmitted using an XML binding over an HTTP transport or an XML binding over a WTP transport (a BXML binding may also be used), the GGSN 24 forwards the request to the IM gateway 28 using an XML binding over an HTTP transport. In this scenario, the network link between the IM gateway 28 and the IM destination server 18 is not secured with a VPN and the HTTP protocol used between these sites in also not secure. However, the IM destination server 18 supports a 4-way login. As a result, a 4-way login may be generated from the 2-way login, as described above with reference to FIG. 4, while the XML binding and HTTP transport are maintained. Again, a 2-way login using an XML binding over an HTTPS transport may also be considered if HTTPS is supported by the IM destination server 18. This scenario corresponds to solution C of Table 1.

In FIGS. 9A and 9B, scenarios similar to those of FIGS. 8A and 8B are respectively presented, wherein the IM client 14 again communicates a 2-way login request to the IM gateway 28 using a first VPN (VPN 1) and an XML binding over an HTTP transport (FIG. 7A) or an XML binding over a WTP transport (FIG. 7B). In these scenarios, however, the IM destination server 18 does not support 4-way logins nor does it support HTTP. As such, a 2-way login using an SMS binding over an SMPP transport is used over a second VPN (VPN 2). This scenario corresponds to solution I of Table 1.

As will be understood by a person of skill in the art, though scenarios A, B, and C assume that an XML binding is used by the IM gateway 28 to connect to the IM server 18, namely since XML is widely supported for 4-way logins, these scenarios may be straightforwardly extended to include the use of an SMS binding if such a binding is supported by the IM server 18.

Also, though scenarios D, E and F assume that a same binding used by the IM client 14 to connect to the IM gateway 28 is used by the IM gateway 28 to connect to the IM server 18, these scenarios may be straightforwardly extended to include binding conversions at the IM gateway 28 from SMS to XML (or BXML) and vice-versa when the latter binding is supported and preferred by the IM server 18.

A person of skill in the art will also understand that other such permutations may be considered and applied to the present system without departing from the general scope and nature of the present disclosure. Namely, examples not explicitly illustrated and/or described herein should be apparent to the person of skill in the art, such as examples wherein a conversion is not required from the IM gateway 28. In those cases, the IM gateway 28 forwards the login request as is to the IM server 18.

Also, scenarios using the BXML binding instead of the XML binding should be readily understood upon reference the above disclosure. Furthermore, scenarios in which the WTPS protocol is used instead of the WTP protocol are very analogous to their WTP counterparts and are not considered to extend the scope and nature of the present disclosure.

Generally, the IM gateway 28 of system 10 is configured to allow a user of an IM client 14 to securely login to an IM service provided on an IM server 18 of his/her choice. The IM gateway 28 ensures that a secure login is available and avoids, when possible, the use of extra VPNs to do so. Also, the IM gateway 28, via gateway module 30, may be required to convert the login request from a transport and binding method supported by the IM client 14 and a transport and binding method supported by the IM server 18. A person of skill in the art will understand that in the event where a 4-way login may already be implemented between the IM client 14 and the IM server 18, the IM gateway 28 need only forward communications therebetween without need for further securing the login process.

Also, even though the above discussion is cast in the context of mobile IM services, the mechanisms described may also apply to other mobile access services, such as for mobile access to email. Namely, protocol incompatibilities between a mobile email client and an email server may also be addressed by an email gateway operating much like the IM gateway 28 of the present disclosure. Furthermore, since login procedures must also be secured between the email client and the email server, login conversions may be considered to reduce, as in the above system 10, the use of VPNs between the various sites involved in the email login procedure. Namely, 2-way and 4-way logins may also be used in the context of wireless email access, and conversions therebetween may be implemented by an email gateway, as described hereinabove in the context of IM services.

In addition, the above discussion may also be applied to other communication systems that do not comply with the general OMA WV IMPS standards. The transports, bindings and login methods discussed herein in the context of a Wireless Village compliant system may be altered without departing from the general scope and nature of the present disclosure. Namely, other login methods may be considered to provide secure login access to Web-type services. A gateway, in accordance with an alternative embodiment of the present invention, could implement various types of secure login procedures based on the requirements and capabilities of the targeted clients and services.

Although an illustrative embodiment of the invention has been described above, it should be understood that this description should not be interpreted in any limiting manner since many variations and refinements are possible without departing from the spirit of the invention. The scope of the invention will be defined in the annexed claims.

What is claimed is:

1. A computer implemented method for communicating a secure login request between a mobile client and a destination server providing access to a service, the method to be implemented by a gateway adapted to communicate with both the mobile client and the destination server, the method comprising the steps of:
a) receiving a login request from the mobile client requesting access to the service, said request comprising login information required to gain access to the service;
b) extracting said login information from said login request;
c) determining a secure login procedure supported by the destination server; and
d) communicating said login information to the destination server in accordance with said secure login procedure.

2. The computer implemented method of claim 1, wherein said secure login procedure comprises at least one of a secure 4-way login procedure and a secure 2-way login procedure.

3. The computer implemented method of claim 2, wherein said secure 2-way login procedure comprises at least one of a 2-way login over HTTPS, a 2-way login over a VPN and a 2-way login over a leased line.

4. The computer implemented method of claim 1, wherein said receiving step comprises receiving said login request in accordance with a client-supported secure login procedure that is different from said secure login procedure supported by the destination server.

5. The computer implemented method of claim 4, wherein said client-supported secure login procedure comprises a secure 2-way login procedure, said secure 2-way login procedure comprising at least one of a 2-way login over HTTPS, a 2-way login over a VPN and a 2-way login over a leased line.

6. The computer implemented method of claim 4, the method further comprising the step after step d) of:
e) receiving a login result from the destination server in accordance with said secure login procedure and communicating said login result to the mobile client in accordance with said client-supported secure login procedure.

7. The computer implemented method of claim 1, the method further comprising the step after step a) of determining a protocol supported by the destination server and communicating said login information to the destination server in accordance with said protocol.

8. The computer implemented method of claim 7, wherein said protocol comprises a binding/transport combination selected from any one of SMS/SMPP, SMS/HTTP, SMS/HTTPS, XML/HTTP, XML/HTTPS, BXML/HTTP and BXML/HTTPS.

9. The computer implemented method of claim 8, said receiving step comprising receiving said login request over a client-supported protocol that is different from said protocol supported by the destination server.

10. The computer implemented method of claim 1, wherein the mobile client comprises an IM client and the destination server comprises an IM server.

11. The computer implemented method of claim 1, wherein the mobile client comprises an email client and the destination server comprises an email server.

12. The computer implemented method of claim 1, wherein said login information comprises a user password required to gain access to the service.

13. A computer implemented method for communicating a login request between a mobile client and a plurality of servers, each of the servers providing access to at least one of a plurality of services, the method to be implemented by a gateway adapted to communicate with both the mobile client and the servers, the method comprising the steps of:
a) receiving a login request from the mobile client requesting access to a service;
b) determining based on said request a destination server selected from said servers providing access to said service;
c) determining a secure login procedure supported by said destination server; and
d) communicating said login request to said destination server in accordance with said secure login procedure.

14. The computer implemented method of claim 13, wherein said secure login procedure comprises at least one of a secure 4-way login procedure and a secure 2-way login procedure.

15. The computer implemented method of claim 13, wherein said secure 2-way login procedure comprises at least one of a 2-way login over HTTPS, a 2-way login over a VPN and a 2-way login over a leased line.

16. The computer implemented method of claim 13, wherein said receiving step comprises receiving said login request in accordance with a client-supported secure login procedure that is different from said secure login procedure supported by said destination server.

17. The computer implemented method of claim 16, the method further comprising the step after step d) of:
e) receiving a login result from said destination server in accordance with said secure login procedure and communicating said login result to the mobile client in accordance with said client-supported secure login procedure.

18. The computer implemented method of claim 16, wherein said client-supported secure login procedure comprises a secure 2-way login procedure, said secure 2-way login procedure comprising at least one of a 2-way login over HTTPS, a 2-way login over a VPN and a 2-way login over a leased line.

19. The computer implemented method of claim 13, the method further comprising the step after step b) of determining a protocol supported by said destination server and communicating said login information to said destination server in accordance with said protocol.

20. The computer implemented method of claim 19, said receiving step comprising receiving said login request over a client-supported protocol that is different from said protocol supported by said destination server.

21. The computer implemented method of claim 13, wherein the mobile client comprises an IM client and said service comprises an IM service.

22. The computer implemented method of claim 13, wherein the mobile client comprises an email client and said service comprises an email service.

23. A gateway for communicating a login request between a mobile client and a plurality of servers, each of the servers providing access to at least one of a plurality of services, the gateway comprising:
a first interface for communicating with the mobile client and adapted to receive a login request therefrom for access to one of the services;
a gateway module in operative communication with said first interface, said module interpreting said login request to determine a destination server selected from said servers providing access to said one of the services and to establish a secure login procedure supported by said destination server; and
a second interface for communicating said login request to said destination server in accordance with said secure login procedure.

24. The gateway of claim 23, wherein said secure login procedure comprises at least one of a secure 4-way login procedure and a secure 2-way login procedure.

25. The gateway of claim 23, wherein said login request is received from the client via said first interface in accordance with a client-supported secure login procedure that is different from said secure login procedure supported by said destination server.

26. The gateway of claim 23, said gateway module further determining a protocol supported by said destination server and communicating said login request to said destination server via said second interface in accordance with said protocol.

27. The gateway of claim 26, wherein said login request is received from the client via said first interface in accordance with a client-supported protocol that is different from said protocol supported by said destination server.

28. The gateway of claim 23, wherein the mobile client comprises an IM client and said one of said services comprises an IM service.

29. The gateway of claim 28, wherein said IM client and said destination server are configured to comply with at least one of OMA IMPS 1.1 standards and OMA IMPS 1.2 standards.

30. The gateway of claim 23, wherein the mobile client comprises an email client and said one of said services comprises an email service.

31. A secure login system for providing access to at least one of a plurality of services, the system comprising:
a plurality of ground end systems each comprising at least one server for providing access to at least one of a plurality of services;
at least one mobile device comprising at least one mobile client for requesting access to at least one of said services; and
a gateway, said gateway comprising:
a first interface for communicating with said mobile client and adapted to receive a login request therefrom for access to one of the services;
a gateway module in operative communication with said first interface, said module interpreting said login request to determine a destination server selected from said servers providing access to said one of the services and to establish a secure login procedure supported by said destination server; and
a second interface for communicating said login request to said destination server in accordance with said secure login procedure.

32. The system of claim 31, wherein said secure login procedure comprises at least one of a secure 4-way login procedure and a secure 2-way login procedure.

33. The system of claim 31, wherein said login request is received from the client via said first interface in accordance with a client-supported secure login procedure that is different from said secure login procedure supported by said destination server.

34. The system of claim 31, said gateway module further determining a protocol supported by said destination server and communicating said login request to said destination server via said second interface in accordance with said protocol.

35. The system of claim 34, wherein said login request is received from the client via said first interface in accordance with a client-supported protocol that is different from said protocol supported by said destination server.
